(19) United States
(12) Patent Application Publication
(10) Pub. No.: US 2016/0177067 A1
(43) Pub. Date: Jun. 23, 2016

(54) Green Material Based Article, Composition, and Method of Producing Same

(71) Applicant: Shawn M. Agosta, Bainbridge Island, WA (US)

(72) Inventor: Shawn M. Agosta, Bainbridge Island, WA (US)

(21) Appl. No.: 14/866,775

(22) Filed: Sep. 25, 2015

Related U.S. Application Data
(63) Continuation-in-part of application No. 13/760,917, filed on Feb. 6, 2013, now abandoned.
(60) Provisional application No. 61/595,196, filed on Feb. 6, 2012.

(51) Int. Cl. C08L 3/02; C08L 89/00

(52) U.S. Cl. CPC C08L 3/02; C08L 89/00

(57) ABSTRACT

Articles of manufacture, compositions of matter, and methods are involved with but are not limited to: substantially uniformly mixing components including at least one or more starch based components, one or more gluten based components, one or more fibrous components, one or more starch agents, and water to produce a mixture; forming said mixture into a predefined shape to produce a formed mixture; treating with curing heat treatment to increase linking within the one or more starch based components involving the one or more starch agents to produce a cured, formed mixture; dehydrating said cured, formed mixture to remove a substantial portion of water to produce a dehydrated, cured, formed mixture; and sealing at least portions of external surfaces to produce a sealed, dehydrated, cured, formed mixture. In addition to the foregoing, other method aspects are described in the claims, drawings, and text forming a part of the present disclosure.

### CLAIM OF PRIORITY

This application claims the benefit of priority under 35 U.S.C. §119(e) to U.S. Provisional Patent Application Ser. No. 61/595,196, filed on Feb. 6, 2012, entitled “Green Building Materal”, the benefit of priority of which is claimed hereby, and of which is incorporated by reference herein in its entirety.

This application claims the benefit of priority under 35 U.S.C. §119(e) to U.S. patent application Ser. No. 13/760,917, filed on Feb. 6, 2013, entitled “Green Materal Based Article, Composition, and Method of Producing Same”, the benefit of priority of which is claimed hereby, and of which is incorporated by reference herein in its entirety.

### SUMMARY

In one aspect, a method includes, but is not limited to; a formed, substantially dehydrated subsequent to forming, substantially uniform mixture of components at least including one or more starch based components, one or more gluten based components, and one or more fibrous based components, said one or more starch based components having been treated to thereby increase linking within said one or more starch based components prior to dehydration. In addition to the foregoing, other method aspects are described in the claims, drawings, and text forming a part of the disclosure set forth herein.

An article of manufacture including: a formed, substantially dehydrated subsequent to forming, substantially uniform mixture of components at least including one or more starch based components, one or more gluten based components, and one or more fibrous based components, said one or more starch based components having been treated to thereby increase linking within said one or more starch based components prior to dehydration.

A composition of matter including: a formable substantially uniform mixture of components at least including one or more starch based components, one or more gluten based components, one or more fibrous based components, and one or more starch agents, said one or more starch agents positioned substantially adjacent to said one or more starch based components to allow for increase in internal linking to occur within said one or more starch based components during a treatment subsequent to forming.

A method including:

substantially uniformly mixing components including at least one or more starch based components, one or more gluten based components, one or more fibrous components, one or more starch agents, and water to produce a mixture;

forming said mixture into a predefined shape to produce a formed mixture;

treating said formed mixture with curing heat treatment to increase linking within the one or more starch based components involving the one or more starch agents to produce a cured, formed mixture;

dehydrating said cured, formed mixture to remove a substantial portion of water from said cured, formed mixture to produce a dehydrated, cured, formed mixture; and

sealing at least portions of external surfaces of said dehydrated, cured, formed mixture to produce a sealed, dehydrated, cured, formed mixture.

In addition to the foregoing, various other aspects are set forth and described in the teachings such as text (e.g., claims and/or detailed description) and/or drawings of the present disclosure. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise.

With reference now to the figures, shown are one or more examples of green material based articles of manufacture, compositions of matter, and/or methods for producing same that may provide context, for instance, in introducing one or more processes and/or devices described herein.

FIG. 1 is a flow chart of a method to produce one or more green material based articles of manufacture and/or compositions of matter.

FIG. 2 is a perspective view of a green material based block form article of manufacture embodiment.

FIG. 3 is a perspective view of a green material based sheet form article of manufacture embodiment.

FIG. 4 is a perspective view of a green material based custom object form article of manufacture embodiment.

FIG. 5 is a perspective view of a green material based rod form article of manufacture embodiment.

FIG. 6 is a perspective view of a green material based post form article of manufacture embodiment.

FIG. 7 is a perspective view of a green material based sphere form article of manufacture embodiment.

FIG. 8 is an exploded perspective view of a green material based drywall form article of manufacture embodiment aligned to be joined to wall studs.

FIG. 9 is a perspective view of the green material based drywall form article of manufacture embodiment of FIG. 8 shown attached to the wall studs of FIG. 8.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present application may use formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Implementations of green material based compositions of matter, articles of manufacture, and methods of producing same can involve building materials associated with fiberous materials, such as cellulosic materials, considered “green” due to a relatively low impact on the environment concerning production, use and/or disposal thereof. Such fiberous materials can include cellulosic materials such as cotton, hemp, paper, other materials originated from cell walls of plants and other so-called “organic” materials. Through use of one or more green based material production methods, compositions of matter and/or articles of manufacture having reduced weight and/or strength increase can be possible along with envisioned reduced impact on environment and energy resources due to possible use of recycled material and possible relative lower energy requirements of production. Possible implementations can include construction implementations such as drywall aspects, floor sheathing aspects, laminate flooring aspects, tile aspects, stenciled wall panel aspects, textured wall board aspects, artificial stone aspects, brick aspects, crown molding aspects, indoor trim aspects, green plywood aspects, decorative cast fixture aspects, insulative door core aspects, sound proofing sheet aspects such as for ships, particle board furniture aspects among other things. Some implementations include having fire rated and/or sound insulative qualities and fungicidal properties.

Green Material Starch Based Component

Implementations of green material based compositions of matter, articles of manufacture, and methods of producing same can involve one or more green material starch based components such as starch or starch derivatives, such as one or more dextrins (dextrines). In general starch includes rice starch. Starch is a naturally abundant nutrient carbohydrate, (C₆H₁₀O₅)ₙ, found chiefly in the seeds, fruits, tubers, roots, grains, and stem pith of plants, notably in corn, potatoes, wheat, and rice, and varying widely in appearance according to source but commonly prepared as a white amorphous tasteless powder. Starch or amylum is a carbohydrate consisting of a large number of glucose units joined by glycosidic bonds. Pure starch is a white, tasteless and odourless powder that is insoluble in cold water or alcohol. It can consist of two types of molecules: the linear and helical amylose and the branched amylopectin. Starch has adhesive characteristics that are utilized as part of the green based material production methods. In some implementations starch or starch derivatives are first added to water, such as cool or cold water since it can be somewhat resistant to break down when added to more than water at first. As further discussed below, the amount of water can vary depending upon amount used of green material based fiberous and/or cellulosic component.

Green Material Gluten Based Component

Implementations of green material based compositions of matter, articles of manufacture, and methods of producing same can involve one or more green material gluten based components such as wheatpaste or other gluten containing green material based sources. The gluten found in wheat, a sticky substance can be composed of the proteins gliadin and glutenin. It has been used since ancient times for various arts and crafts such as book binding, decoupage, collage, and papier-mâché. It is also made for the purpose of adhering paper posters to walls and other surfaces (often in graffiti). Alternatives can include such as wallpaper pastes. Other alternatives can also include such as potato paste, flour paste, rice paste, Marxist glues, or simply paste such as a liquid adhesive made from vegetable starch and water. Green material based gluten based components can often made by mixing portions of flour and water and heating it until it thickens, or some alternatives can be made by smearing cooked rice into a paste.

Boron Containing Matter Based Component

Implementations of green material based compositions of matter, articles of manufacture, and methods of producing same can involve one or more green material boron containing components such as one or more borates or other boron containing green material based sources.

Borax, also known as sodium borate, sodium tetraborate, or disodium tetraborate, is an important boron compound, a mineral, and a salt of boric acid. Powdered borax is white, consisting of soft colorless crystals that dissolve easily in water. Borax has a wide variety of uses, some of which can be utilized in green material based articles of manufacture, compositions of matter, and methods of producing same. For instance, it can be used to make as a fire retardant, as an anti-fungal compound, insecticide, a texturing agent, acaricide, algaecide, herbicide, fungicide and as a precursor for other boron compounds.

The term borax is used for a number of closely related minerals or chemical compounds that differ in their crystal water content, but usually refers to the decahydrate. Commercially sold borax is usually partially dehydrated.

The one or more green material boron containing components can include sodium borate decahydrate; borax; sodium pyroborate sodium tetraborate decahydrate; disodium tetraborate decahydrate, boric acid derivatives, disodium octaborate and sodium metaborate. Both sodium tetraborate and disodium octaborate occur in several hydration states. Sodium tetraborate decahydrate is also known as borax.

Boron Containing Matter and Starch Matter Combination

Borates Serve as Multifunctional Additives with Binder/Adhesive, Flame retardant and fungicidal properties. As further discussed above dextrine/starch-based adhesives are made from natural polymers derived from roots, tubers and seeds of higher plants such as maize, potatoes, wheat, rice and tapioca. Starch based adhesive is either cold or warm water-soluble depending on the application. If borax is added in the presence of small amounts of sodium hydroxide, it can change the starch polymer to a more highly branched chain polymer with higher molecular weight. The precise composition of adhesives varies by application but in implementations can include adding up to 10% or more of borate to the dextrine/starch. Aqueous sodium hydroxide and other constituents are added and the mixture is ‘cooked’. The presence of sodium hydroxide leads to the formation of sodium metaborate which, in turn, can lead to the formation of borate-starch complex (Baumann and Conner, 1994). In some applications, the concentrations can be somewhat lower such as concentration is between 3% and 6% calculated as dry starch adhesive. Other implementations can include a level of borax ranging from 0.4% to 1.3% in the dried product, depending on the use. In corrugated board systems, the level of borax mix can be a quarter of the level referred to above (i.e. 0.1% to 0.3%). In other implementations borax is used for starch glue at concentrations of 0.3% to 0.5%.

Green Material Fiberous Cellulosic Based Component

Implementations of green material based compositions of matter, articles of manufacture, and methods of producing same can involve one or more green material fiberous and/or cellulosic components. Cellulose is a complex carbohydrate, (C₆H₁₀O₅)ₙ, that is composed of glucose units, forms the main constituent of the cell wall in most plants. Cellulose is includes a consisting of a linear chain of several hundred to over ten thousand β(1→4) linked D-glucose units. For industrial use, cellulose today is mainly obtained from wood pulp and cotton. Converting cellulose from energy crops into biofuels such as cellulosic ethanol is under investigation as an alternative fuel source.

Cellulose fibers can range in size from production methods including shredding, pulverizing, grinding, and other methods to produce even smaller particle sizes. Particle size such as on the order of less than 10 mm to below 1 mm can be used in implementations. Other implementations can utilize nano-size particle sizes. In some implementations hammer milling of new or used paper products can be used to produce fibrous cellulosic particle components.

Some cellulose insulation products contain cellulose fibers that are dusted by one or more borates as fire retardants. The mixture of cellulose and borate containing material is can be a convenient source of both the fiberous and the boron containing components for green material based production methods. For instance, an exemplary product from Green Fiber™ cellulose insulation, loose fill blended formula includes newsprint cellulose fiber not less than 85%, boric acid H3BO3 not more than 10%, ammonium sulfate (NH4)2 SO4 not more than 11%, zinc sulfate ZnSO4-H2O not more than 2%, distillate mineral oil not more than 2%. Another exemplary product from Green Fiber™ cellulose insulation, loose fill blended formula includes newsprint cellulose fiber not less than 85%, boric acid H3BO3 not more than 15%, sodium tetraborate pentahydrate Na2B4O7-5H20 not more than 10%, distillate mineral oil not more than 2%.

Green Material Based Component Mixing

Green material based component mixing implementations can include steps using three or four mixing vessels (two for wet ingredients and one for dry ingredients) Implementations of green material based articles of manufacture and compositions of matter production methods can be carried out with vessels or suitable containers, for instance, such as three, provided that one is large enough to contain and mix all of the ingredients—both wet and dry.

In exemplary implementations, three separate sub-processes can be performed:

a. a first quantity of green material gluten based component is in a dry form, for instance, from 8 oz. to 16 oz, such as, potato paste, flour paste, organic glue, wheat paste is mixed with, for instance, from 5 qts to 15 qts water in a vessel to create the gluten based adhesive wet ingredient);

b. a second quantity of green material starch based component, such as potato starch, rice starch, or a starch derived from organic plant matter, for instance, from 2 oz. to 10 oz. is mixed with water in a second vessel to create a wet ingredient hardener and strengthener; and

c. a third quantity of green material fiberous cellulosic component, such as of cellulose measured and weighed from, for instance, about 30 oz. to 60 oz which may include a mixture of recycled paper particles or such as hemp particles of greater or less that mm size further described above. As further described above, the cellulose mixture can be ground and mixed with a anywhere from 5 to 25% of organic mold and fire retardant such as baking soda, salt, borax, sodium borate in a separate vessel (dry ingredients). Ingredient mixtures of the three mixtures will vary according to the desired characteristics of the resulting products.

In an exemplary implementation, wet mixtures of starch based and gluten based materials are combined and mixed thoroughly, which can be accomplished in one of the original vessels provided the vessel is large enough to accommodate the combined main mixture. Following this mixing, the prepared cellulose mixture can be added and thoroughly mixed with the mixed wet mixtures of starch based and gluten based materials. As described, this cellulose component can be prepared by grinding it and then dusting it with the appropriate amount from 5 to 25% of organic mold and fire retardant such as baking soda, salt, sodium borate, which is non-toxic and can be used as a fire retardant, insect fighter, and mold preventer. As described above adding the organic mold and fire retardant such as baking soda, salt, sodium borate also contributes to the cohesiveness of the main mixture since there can be a possible reaction with the starch to increase cross-linking of the starch molecules thereby increasing strength chararistics of the resultant articles of manufacture.

It is important that the mixing continue until the mixture is homogeneous throughout so that the cellulose has absorbed the slurry of wet ingredients and so that the fire retardant and sound insulative qualities will be consistent in the final product. The main mixture will now be similar to wet cellulose clay that is slightly sticky and heavy.

Once the main mixture contains all of the ingredients and is homogeneous throughout then the shaping may begin. The main mixture will lend itself to any shape imaginable, and the shaping step should be performed with the final application of the product in mind. Shaping can be accomplished using various molds, extrusion machines, etc.

Implementations of the vessels can include any that for the dry starch based component and gluten based component paste any container sufficiently large to hold the contents and be weighed. The vessel containing the water needs to be large enough to take on the the starch based component and the gluten based component and the cellulose component dusted with starch reactive agent such sodium borate.

For example, a vessel large enough to hold from 5 to 50 gallons of water along with the ingredients of starch based component, gluten based component, and cellulose based component. The vessel to initially mix the starch based component with water would then range from 5 to 50 oz. The vessel to initially mix the gluten based component would then range from 10 to 100 oz.

In this example, the cellulose based component will then be added in after all the wet starch based component and the wet gluten based component have been well mixed. For this example, the average amount the cellulose based component will vary in the ranges of one to two hundred pounds. The starch reactive agent, such as sodium borate can be added to the cellulose based component at five to twenty percent of the total weight.

Green Material Based Curing Phase

Curing is a term in polymer chemistry and process engineering that refers to the toughening or hardening of a polymer material by cross-linking of polymer chains, brought about by chemical additives, or heat. After the starch based component, gluten based component, cellulose component, and starch reactive agent (such as boron containing component) are all thoroughly mixed together with water and the mixture is shaped into a desired form by molding, extrusion, etc., the shaped mixture undergoes a curing phase with heat to allow for the starch reative agent and starch contained within the shaped mixture to increase cross-linking between the starch molecules thereby forming a more integral starch matrix made up of enhanced cross-linked starch molecules to impart increased strength to articles of manufacture resultant from the green material based production method.

For implementations, the curing phase involves heating the formed mixture at least momentarily from 175 F to 225 F such as by a convention oven or similar heating mechanism. Other implementations may have other curing temperatures but too high of temperatures can possibly result in embrittlement of the resultant of the articles of manufacture. Too low of temperatures can possibly result in less than sufficient or satisfactory enhanced cross-linking of the starch molecules resident within the formed mixture thus producing a less than desirable strength characteristic of the articles of manufacture produced thereby. As mentioned the enhanced cross-linking through curing of the starch molecules and starch reactive agent, such as boron containing material within the formed mixture increases strength of the resultant articles of manufacture. However, without the presence of the gluten based component within the formed mixture, the resultant articles of manufacture would not have sufficient density to be used for many purposes such as found in the construction industry such as for example drywall. For example, without the gluten based component within the formed mixture the resultant articles of manufacture if used as a drywall would not have sufficient density to receive nails and be able to provide supportive strength necessary for drywall applications.

Green Material Based Dehydrating Phase

After curing the starch reactive agent (e.g. a boron containing component such as borate) with the starch based component within the formed mixture, the formed mixture is then further dehydrated a low heating temperature, such as between 100 F to 150 F until the preformed mixture is sufficiently dry to be considered solid sufficient for its intended serviceable function. Such drying can be accomplished through low temperature ovens or rooms with sufficient circulating air to achieve drying. Drying times can vary with thickness of the form mixtures as well as other factors including particular composition mixture. Time of exposure and temperature of the drying air will effect resultant quality such that without sufficient time or temperature undesirable moisture may remain or with too much temperature or time there maybe a resultant embrittlement.

Green Material Based Sealing Phase

Once the formed mixture has been cured and dehydrated to reduce its internal moisture content to a sufficient level, in implementations, at least the external surfaces exposed to air or other atmospheric conditions receive one or more coats of a sealant to prevent absorption by the dried formed mixture of water from the such air contacting such external surfaces. One or more sealants used can be either a green, organic based sealant such as an organic latex water sealant or laminant or a conventional sealant or laminant. Such green, organic based sealants can include such sealants as exemplary Safecoat DynoSeal, Safecoat WaterShield, SoySeal Wood Sealer and Waterproofer, SoyGuard Wood Sealer and Water Repellent, Rainforest Sealer, Zerovoc ZR44 Clear, Water Repelling Wood Sealer, Seal-Once™ eco-friendly waterproofers, and Aqua-Tite® GREEN Waterproofing. Conventional sealants can include Thompson Water Sealer, Dow Corning Water Sealer, Behr Water Sealer, Home Armor Waterproofing, and Olympic Water Guard.

General Green Material Based Production Method Description

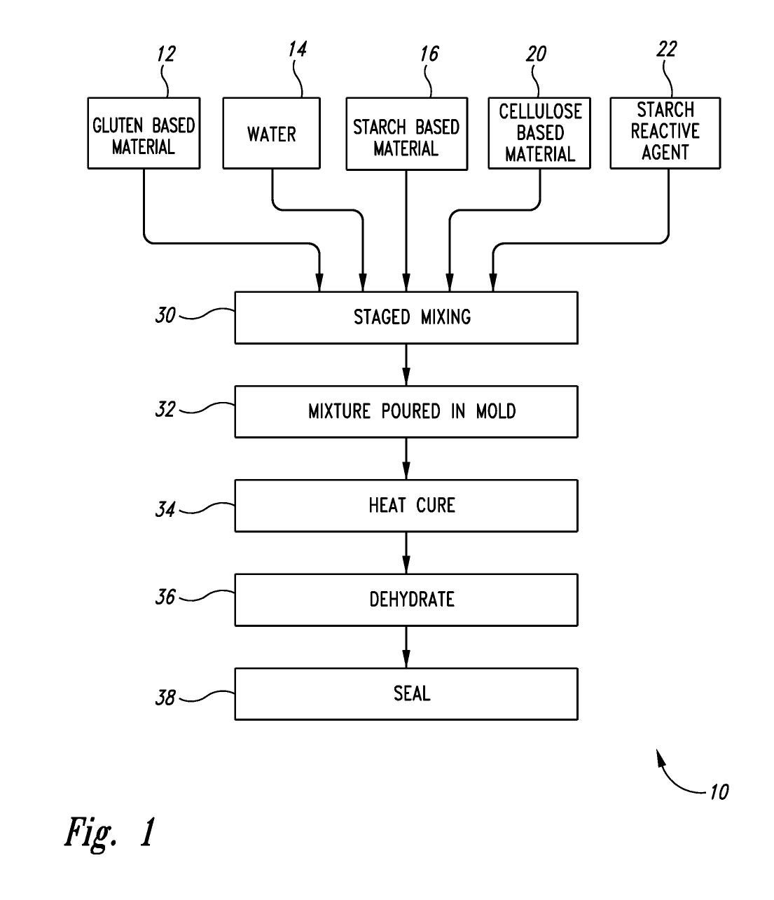

As shown in FIG. 1 a green material based method 10 for production of compositions of matter and articles of manufacture is depicted as combining constituents including at least gluten based material 12, water 14, starch based material 16, cellulose based material 20, and starch reactive agent 22 (e.g. one or more boron containing substances such as one or more borates) with a staged mixing 30. Examples of the staged mixing 30 have been described above to involve one or more particular orders of mixing of various constituents, but are not intended to be limiting solely to these particular one or more described orders of mixing, but rather encompass any order of mixing that will accomplish the formed mixture described above as being a thorough mixture of at least such constituents enumerated in FIG. 1. After the staged mixing 30, the green material based method 10 including a mixture poured in mold 32 resulting in a formed mixture. Other techniques resulting in a formed mixture can include extrusion, etc. A heat cure 34 then occurs thereafter to assist with strengthening through increased cross-linking of the starch molecules contained within the formed mixture as described further above. A dehydrate 36 then removes residual moisture from within the formed mixture followed by a seal 38 to prevent moisture from being reintroduced into the dried out formed mixture thereby resulting in one or more articles of manufacture.

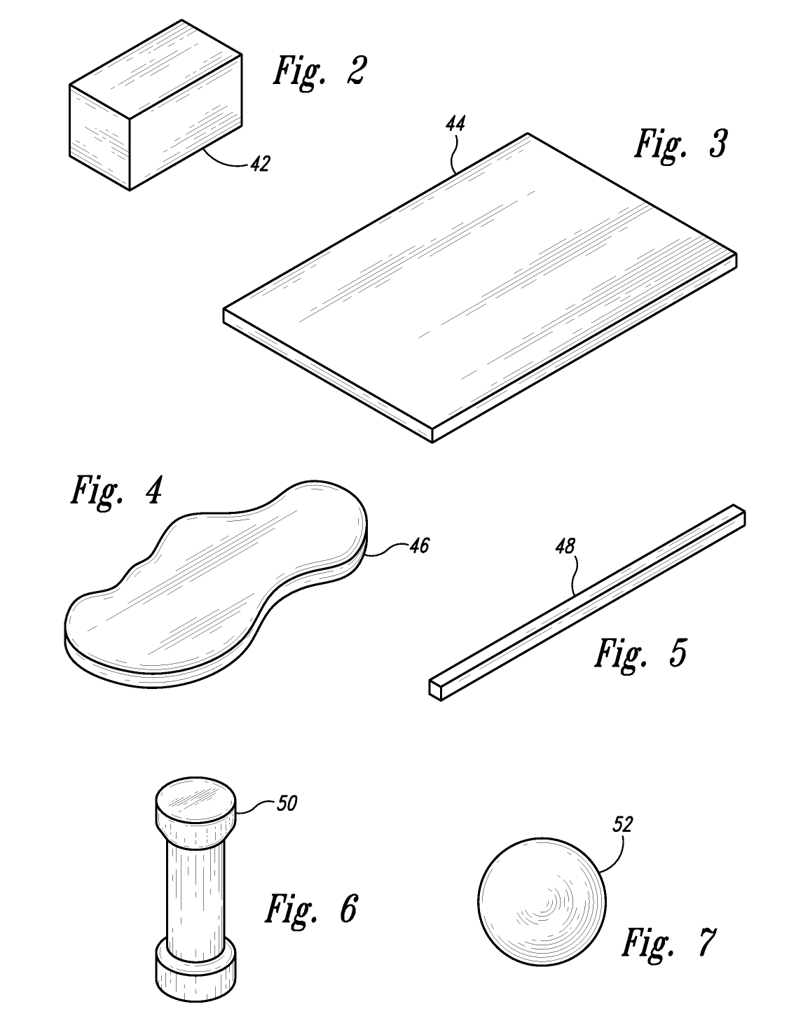

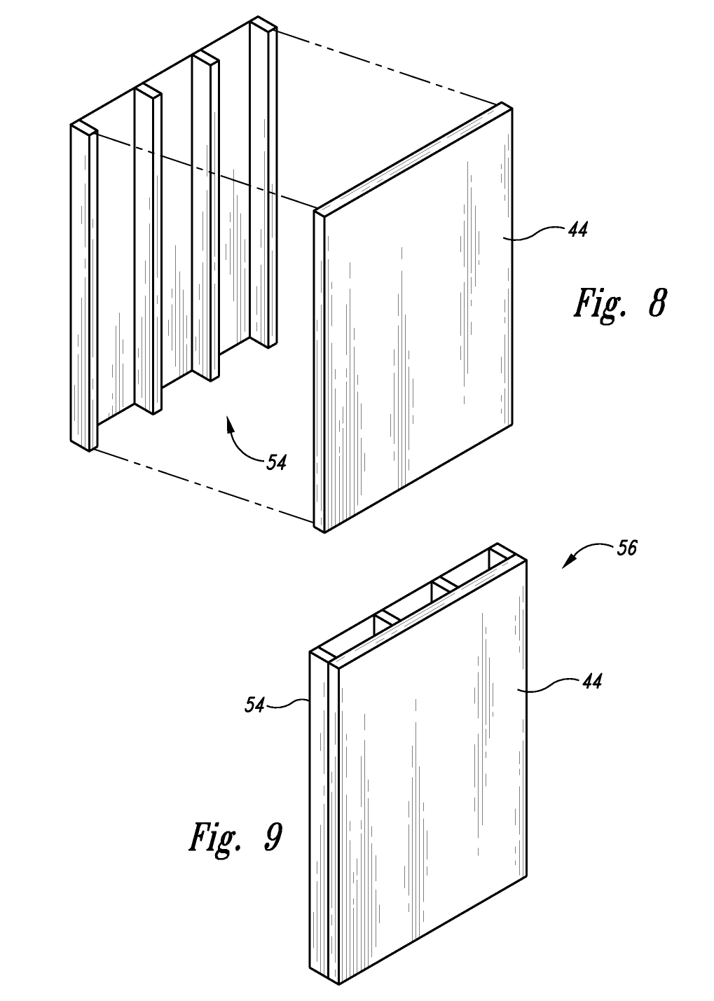

FIGS. 2-9 show a few of the various shapes of articles of manufacture that can result from the green material based method 10 of FIG. 1 and intended only as representative rather than limiting of such resultant articles. FIG. 2 depicts a green material based block or brick form 42 article of manufacture embodiment. FIG. 3 depicts a green material based sheet form 44 article of manufacture embodiment that can be used for such applications as walls, such as drywall, floors, doors, furniture, etc. FIG. 4 depicts a shaped custom object form 46 article of manufacture embodiment having application such as mock rock, statue, collection of individual rocks, stones, bricks, etc. FIG. 5 depicts a green material based rod form 48 article of manufacture embodiment can have a long, thin shape that could be used for such as crown molding, wall trim, etc. FIG. 6 depicts a green material based post form 50 article of manufacture embodiment that can have a long, thin shape that could be used for such as crown molding, wall trim, etc. FIG. 7 depicts a green material based sphere form 52 article of manufacture embodiment. FIG. 8 depicts an exploded perspective view of a green material based sheet form 44 as a drywall article of manufacture embodiment aligned to be joined to wall studs 54. FIG. 9 depicts the green material based sheet form 44 as the drywall article of manufacture embodiment of FIG. 8 shown attached to the wall studs 54 of FIG. 8 to form a room wall 56.

Examples of Green Based Material Articles of Manufacture

Examples of green based material articles of manufacture as building materials are further described below. As described above, water incorporates the other ingredients into a wet homogeneous mixture. For example, a vessel can be used large enough to hold from 5 to 50 gallons of water along with the ingredients of starch based component (e.g. 5 to 50 oz.), gluten based component (e.g. 10 to 100 oz.), cellulose based component (e.g. one to two hundred pounds), and starch reactive agent (e.g. as boron containing component, as borate, such as sodium borate, such as five to twenty percent of total cellulose weight). Generally the cellulose based component is added once the other components are well mixed.

Wall Board/Drywall Example

A wall board, drywall exemplary implementation includes approximately 4 to 48 oz of starch based component. 12 to 148 oz of gluten based component mixed with water to produce 5 to 25 gallons of wet ingredients including cellulose based component and starch activating agent (such as boron containing component). The slurry so formed can be done so with machinery to push the slurry of paper clay into the desired forms of length, width, and thickness to produce a formed mixture. Subsequently, the formed mixture will proceed on a conveyor through air circulating ovens initially at a temperature of 175 to 225 F for curing of the starch with the starch activated agent (such as borate) and the starch based component. When the board has reached desired curing temperature momentarily sufficiently for curing, the board embodiment formed article of manufacture will continue through oven space of reduced temperature in a range such as 100 to 150 F sufficient to accomplish desired dehydration. After dehydration, subsequent sealing results in a wall board, drywall article of manufacture embodiment.

Second Wall Board/Drywall Example

Another wall board, drywall implementation producing a 4 ft×8 ft ⅝ sheet of wallboard could be produced with the following components. Included as a vessel having 60 to 120 qts of water, leaving enough room for the other components to be mixed. The gluten based component of 50 to 120 oz can be included. The starch based component of approximately 20 to 48 oz can be included. The cellulose components along with the starch activating agent such as borate are mixed into the liquid slurry. Although other implementations can have other orders of mixing, in this example the starch based component is first thoroughly mixed with water. This mixture is then thoroughly combined with the gluten based component. Thereafter the cellulose based component of 220 to 450 oz along with a blended 5 to 25% of organic mold and fire retardant acting as a starch reacting agent such as baking soda,

salt, borax, sodium borate. Dry ingredients are poured into a liquid slurry and mix thoroughly to a wet cellulose clay that is slightly sticky and heavy. In a form or mold that is approximately anywhere from 4 ft to 5 ft wide, 8 ft×9 ft long, and ½ to 1.5 in deep. To compensate for shrinkage the wet mixture is poured into the form and fill the form completely. A long roller can be used to push the mixture into the form evenly and smoothly. The sheet needs to be put unto a large drying rack that allows hot air to pass under and over evenly. A large heated air circulating oven could then be used. Alternatively, a large well heated room could be used for subsequent curing and dehydrating. Fans can be placed thereby directing flow of warm air across the sheet being dried. Drying time will vary accordingly. Once the board is dry sufficiently to allow for use of the article of manufacture embodiment as drywall, the board can be cut to desired size. The board is also sealedxwith a moisture sealer such as an organic latex. After the sheet is produced to specification a thin cardboard sheet can be added to the wallboard by brushing the cardboard sheet to be applied with a slurry of starch based component and pressed to adhere to the wallboard. Once dried the thin cardboard layer will act as the finished side of your wallboard.

Floor Sheathing Example

A floor sheathing article of manufacture embodiment uses a formed mixture composition with increased gluten based component to increase density in the resultant board form article of manufacture embodiment. These floor sheathing board embodiments can then be used as an under lament for wood floors and linoleum. An exemplary composition mixture for the floor sheathing board embodiments can use approximately 4 to 32 oz of starch based component, and 12 to 180 oz of gluten based component. A vessel can be used configured to hold 5 to 30 gallons of all wet ingredients including the paper/cellulose based component and starch reactive component. The resultant formed mixture can be conveyed through air circulating ovens with initial temperature from 175 to 225 F for curing of starch reacting agent such as borate with the starch based component. When the floor sheathing board embodiment reaches the curing temperate it can continue through a cooler temperature room or oven between approximately 100 F and 150 F for time sufficient for thorough internal drying to be ready to receive moisture sealant.

Laminate Flooring and Tile Example

A laminate flooring and tile article of manufacture embodiments are produced similarly as the floor sheathing board embodiment example described above. A difference between these two methods involves treatment after the articles are dried. The laminate flooring and tile article of manufacture embodiments can be cut into uniform tiles to be laminated with desired design and texture.

Stenciled Wall Panel Example

Stenciled wall panel article of manufacture embodiments will be processed similarly as wall board/drywall article of manufacture embodiments.

Approximately 4 to 48 oz of starch based component, 12 to 148 oz of gluten based component mixed with water in a vessel that can hold 5 to 25 gallons of all wet ingredients including paper/cellulose based component and starch reactive agent. The slurry will be formed through a machine that can push the slurry of paper clay into the desired forms of length, width, and thickness. The exception being as they are put into there required forms they will be stenciled with a stone, brick, or design element press that will be pressed into the wet form. They then will proceed through the same drying process. After they will be moisture sealed as well.

Textured Wall Board Example

Textured wall board article of manufacture embodiments can be processed similarly to stenciled wall panel article of manufacture embodiments. A difference with these methods is that the present embodiment can be pressed into forms with a textured roller that will add an artistic appearance to the panels.

Individual Rocks, Stones and Brick Example

Individual rocks, stones and bricks article of manufacture embodiments can be made to have a density greater relative to those described above. For instance, use of 8 to 60 oz of starch based component, 16 to 172 oz of gluten based component mixed in with water in a vessel holding holding 5 to 50 gallons of all wet ingredients including paper/cellulose based component and starch reactive agent. The mixture is pressed into a form to produce a formed mixture of a thicker density than examples previously described. Due to increased density curing and dehydrating times can be adjusted accordingly.

Crown Moulding and Trim Example

Crown moulding and trim article of manufacture embodiments will be processed using similar amounts of ingredients as the floor sheathing article of manufacture embodiments described above. After the ingredients have been mixed, the wet mixture will be put into selected forms that will emboss the desired trim as desired. Once the wet mixture has taken on the desired trim form and embossing it will be sent through similar curing and drying process and sealing as described above.

Green Plywood Example

Green plywood article of manufacture embodiments can include approximately 4 to 32 oz of starch based component and 12 to 180 oz of gluten based component. A vessel can be used that can hold 5 to 30 gallons of all wet ingredients including paper/cellulose based component and starch reactive agent. Sealing will include several coats of a moisture sealant. The mixture is pressed into a form to produce a desired density.

Decorative Cast Fixtures Example

Decorative cast fixture article of manufacture embodiments can include varied amounts of ingredients to create cast differing figure. Variability in density will exist through a spectrum product availability. For instance, 4 to 32 oz of starch based component, 12 to 120 oz of gluten based component can be mixed in a vessel of water holding 5 to 25 gallons of all wet ingredients including paper/cellulose based component and starch reactive agent. The ingredients will be pressed into forms that create the desired appearance. Once the wet mixture has been pressed into the desired form they will continue in the form through the same curing and drying time as all the other above mentioned building materials. At the end of the drying process the forms will be released from the product and the decorative fixture will be coated with a moisture sealant.

Door Insulation Cores Example

Door insulation core article of manufacture embodiments can use approximately 4 to 32 oz of starch based component, 12 to 120 oz of gluten based component all mixed in a water vessel holding 5 to 25 gallons of wet ingredients including paper/cellulose based component and starch reactive agent. The ingredients will be pressed into the desired thickness, length, and width then will proceed through the curing and drying processes followed by sealing with a moisture sealant.

Sound Proofing Sheets of Ships Example

Sound proofing sheet for ships article of manufacture embodiments—These items will be made in a more dense manner by using approximately 8 to 60 oz of starch based component, 16 to 172 oz of gluten based component mixed in a water vessel holding 5 to 50 gallons of all wet ingredients including paper/cellulose based component and starch reactive agents. The wet mixture can be pressed into a form that can create a relatively denser product. Because this is a denser product, the drying time will vary accordingly.

Particle Board Furniture Example

Particle board furniture article of manufacture embodiments can use approximately 4 to 32 oz of starch based component, 12 to 180 oz of gluten based component. A vessel can be used to hold 5 to 30 gallons of all wet ingredients including paper/cellulose based component and starch reactive agent. The formed mixture will be conveyored through air circulating ovens with initial temperature from 175 to 225 degree for curing and continuing at lower temperatures for remaining drying. After drying subsequent sealing is performed with a moisture sealant and desired laminate.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Aspects of Green Material Based Article, Composition, and Method of Producing Same

1. An article of manufacture comprising:

a formed, substantially dehydrated subsequent to forming, substantially uniform mixture of components at least including one or more starch based components, one or more gluten based components, and one or more fibrous based components, said one or more starch based components having been treated to thereby increase linking within portions of said one or more starch based components prior to dehydration.

See aspects described otherwise herein as well as following explicitly enumerated aspects.

formed: e.g. wet, slurry, or otherwise fluid or semi-fluid pre-dehydrated substantially uniform mixture can be poured or otherwise introduced into forms, molds, extruded to form predefined shapes such as wall board/drywall, floor sheathing, laminate flooring and tiles, stenciled wall panels, textured wall boards, individual rocks, stones, and brick; crown molding and trim; green plywood; decorative cast fixtures; door insulation cores; sound proofing sheets of ships, particle board furniture and also including above described aspects.

substantially dehydrated: e.g. water moisture content dependent upon application such as less than 10%, less than 9%, less than 8%, less than 7%, less than 6%, less than 5%, less than 4%, less than 3% less than 2%, or less than 1%, etc., or of total weight of article, or such as the formed mixture is then further dehydrated a low heating temperature, such as between 100 F to 150 F until the preformed mixture is sufficiently dry to be considered solid sufficient for its intended serviceable function and also including above described aspects.

substantially uniform mixture of components: e.g. through mechanical blending of dry components, through thorough mechanical mixing of wet slurries, of wet pastes, and also including above described aspects.

starch based components: e.g. one or more starches with large numbers of glucose units joined by glycosidic bonds such as starch from rice, corn, potatoes, etc., or starch derivatives such as one or more dextrins (dextrines) and also including above described aspects.

gluten based components: e.g. wheatpaste, other gluten containing materials or compounds, and other sticky substances that include gliadin and glutenin proteins and also including above described aspects.

fibrous based components: e.g. cellulosic materials such ground, milled, or hammer milled, millimeter sized or nanometer sized or other sized, new or recycled, cotton, hemp, paper, cardboard, recycle paper and also including above described aspects.

treated: e.g. cured through raising temperature to between 175 F to 225 F for a sufficient time to allow through a starch agent such a boron containing chemical compound such as a borate to result in cross linking between at least some of the starch molecules or molecules of one or more starch derivatives to be increased thereby allowing for potential for greater strength in resultant article of manufacture and also including above described aspects.

increase linking within portions of said one or more starch based components: e.g. cured through raising temperature to between 175 F to 225 F for a sufficient time to allow through a starch agent such a boron containing chemical compound such as a borate to result in cross linking between at least some of the starch molecules or molecules of one or more starch derivatives to be increased thereby allowing for potential for greater strength in resultant article of manufacture and also including above described aspects.

furthermore sealed: e.g. once the formed mixture has been cured and dehydrated to reduce its internal moisture content to a sufficient level, in implementations, at least the external surfaces exposed to air or other atmospheric conditions receive one or more coats of a sealant to prevent absorption by the dried formed mixture of water from the such air contacting such external surfaces. One or more sealants used can be either a green, organic based sealant such as an organic latex water sealant or laminant or a conventional sealant or laminant. Such green, organic based sealants can include such sealants as exemplary Safecoat DynoSeal, Safecoat WaterShield, SoySeal Wood Sealer and Waterproofer, SoyGuard Wood Sealer and Water Repellent, Rainforest Sealer, Zerovoc ZR44 Clear, Water Repelling Wood Sealer, Seal-Once™ eco-friendly waterproofers, and Aqua-Tite® GREEN Waterproofing. Conventional sealants can include Thompson Water Sealer, Dow Corning Water Sealer, Behr Water Sealer, Home Armor Waterproofing, and Olympic Water Guard and also including above described aspects.

2. A composition of matter comprising:

a formable substantially uniform mixture of components at least including one or more starch based components, one or more gluten based components, one or more fibrous based components, and one or more starch agents, said one or more starch agents present to allow for increase in linking to occur within portions of said one or more starch based components during a treatment subsequent to forming.

See aspects described otherwise herein as well as following explicitly enumerated aspects.

formable: e.g. being able to be formed such as through wet, slurry, or otherwise fluid or semi-fluid pre-dehydrated substantially uniform mixture being poured or otherwise introduced into forms, molds, extruded to form predefined shapes such as wall board/drywall, floor sheathing, laminate flooring and tiles, stenciled wall panels, textured wall boards, individual rocks, stones, and brick; crown molding and trim; green plywood; decorative cast fixtures; door insulation cores; sound proofing sheets of ships, particle board furniture and also including above described aspects.

starch agents: e.g. chemical compounds involved with curing through raising temperature to between 175 F to 225 F for a sufficient time to allow through the starch agent such a boron containing chemical compound such as a borate to result in cross linking between at least some of the starch molecules or molecules of one or more starch derivatives to be increased thereby allowing for potential for greater strength in resultant article of manufacture and also including above described aspects.

allow for increase in linking to occur within portions of said one or more starch based components: e.g. use of chemical compounds involved with curing through raising temperature to between 175 F to 225 F for a sufficient time to allow through the starch agent such a boron containing chemical compound such as a borate to result in cross linking between at least some of the starch molecules or molecules of one or more starch derivatives to be increased thereby allowing for potential for greater strength in resultant article of manufacture and also including above described aspects.

during treatment: e.g. use of chemical compounds involved with curing through raising temperature to between 175 F to 225 F for a sufficient time to allow through the starch agent such a boron containing chemical compound such as a borate to result in cross linking between at least some of the starch molecules or molecules of one or more starch derivatives to be increased thereby allowing for potential for greater strength in resultant article of manufacture and also including above described aspects.

subsequent to forming: e.g. forming such as through wet, slurry, or otherwise fluid or semi-fluid pre-dehydrated substantially uniform mixture being poured or otherwise introduced into forms, molds, extruded to form predefined shapes such as wall board/drywall, floor sheathing, laminate flooring and tiles, stenciled wall panels, textured wall boards, individual rocks, stones, and brick; crown molding and trim; green plywood; decorative cast fixtures; door insulation cores; sound proofing sheets of ships, particle board furniture and also including above described aspects.

3. A method comprising:

substantially uniformly mixing components including at least one or more starch based components, one or more gluten based components, one or more fibrous components, one or more starch agents, and water to produce a mixture;

forming said mixture into a predefined shape to produce a formed mixture;

treating said formed mixture with curing heat treatment with one or more starch agents to increase linking within portions of the one or more starch based components to produce a cured, formed mixture;

dehydrating said cured, formed mixture to remove a substantial portion of water from said cured, formed mixture to produce a dehydrated, cured, formed mixture; and

sealing at least portions of external surfaces of said dehydrated, cured, formed mixture to produce a sealed, dehydrated, cured, formed mixture.

See aspects described otherwise herein as well as following explicitly enumerated aspects.

substantially uniformly mixing components including at least one or more starch based components, one or more gluten based components, one or more fibrous components, one or more starch agents, and water to produce a mixture: e.g. As shown in FIG. 1 a green material based method 10 for production of compositions of matter and articles of manufacture is depicted as combining constituents including at least gluten based material 12, water 14, starch based material 16, cellulose based material 20, and starch reactive agent 22 (e.g. one or more boron containing substances such as one or more borates) with a staged mixing 30. Examples of the staged mixing 30 have been described above to involve one or more particular orders of mixing of various constituents, but are not intended to be limiting solely to these particular one or more described orders of mixing, but rather encompass any order of mixing that will accomplish the formed mixture described above as being a thorough mixture of at least such constituents enumerated in FIG. 1.

e.g. a first quantity of green material gluten based component is in a dry form, for instance, from 8 ounces to 16 ounces wheat paste is mixed with, for instance, from 5 quarts to 15 quarts water in a vessel to create the gluten based adhesive wet ingredient); starch derived from organic plant matter, for instance, from 2 ounces to 10 ounces, and about 30 ounces to 60 ounces which may include a mixture of recycled paper particles or such as hemp particles of greater or less that mm size further described above. As further described above, the cellulose mixture can be ground and mixed with a anywhere from 5 to 25% of organic mold and fire retardant such as baking soda, salt, borax, sodium borate in a separate vessel (dry ingredients).

e.g. a vessel large enough to hold from 5 to 50 gallons of water along with the ingredients of starch based component, gluten based component, and cellulose based component. The vessel to initially mix the starch based component with water would then range from 5 to 50 ounces. The vessel to initially mix the gluten based component would then range from 10 to 100 ounces In this example, the cellulose based component will then be added in after all the wet starch based component and the wet gluten based component have been well mixed. For this example, the average amount the cellulose based component will vary in the ranges of one to two hundred pounds. The starch reactive agent, such as sodium borate can be added to the cellulose based component at five to twenty percent of the total weight.

e.g. water incorporates the other ingredients into a wet homogeneous mixture. For example, a vessel can be used large enough to hold from 5 to 50 gallons of water along with the ingredients of starch based component (e.g. 5 to 50 ounces), gluten based component (e.g. 10 to 100 ounces), cellulose based component (e.g. one to two hundred pounds), and starch reactive agent (e.g. as boron containing component, as borate, such as sodium borate, such as five to twenty percent of total cellulose weight). Generally the cellulose based component is added once the other components are well mixed.

e.g. approximately 4 to 48 ounces of starch based component. 12 to 148 ounces of gluten based component mixed with water to produce 5 to 25 gallons of wet ingredients including cellulose based component and starch activating agent (such as boron containing component). The slurry so formed can be done so with machinery to push the slurry of paper clay into the desired forms of length, width, and thickness to produce a formed mixture.

e.g. 60 to 120 quarts of water, leaving enough room for the other components to be mixed. The gluten based component of 50 to 120 ounces can be included. The starch based component of approximately 20 to 48 ounces can be included. The cellulose components along with the starch activating agent such as borate are mixed into the liquid slurry. Although other implementations can have other orders of mixing, in this example the starch based component is first thoroughly mixed with water. This mixture is then thoroughly combined with the gluten based component. Thereafter the cellulose based component of 220 to 450 ounces along with a blended 5 to 25% of organic mold and fire retardant acting as a starch reacting agent such as baking soda, salt, borax, sodium borate.

e.g. approximately 4 to 32 ounces of starch based component, and 12 to 180 ounces of gluten based component. A vessel can be used configured to hold 5 to 30 gallons of all wet ingredients including the paper/cellulose based component and starch reactive component.

e.g. approximately 4 to 48 ounces of starch based component, 12 to 148 ounces of gluten based component mixed with water in a vessel that can hold 5 to 25 gallons of all wet ingredients including paper/cellulose based component and starch reactive agent.

e.g. use of 8 to 60 ounces of starch based component, 16 to 172 ounces of gluten based component mixed in with water in a vessel holding 5 to 50 gallons of all wet ingredients including paper/cellulose based component and starch reactive agent.

e.g. approximately 4 to 32 ounces of starch based component and 12 to 180 ounces of gluten based component. A vessel can be used that can hold 5 to 30 gallons of all wet ingredients including paper/cellulose based component and starch reactive agent.

e.g. 4 to 32 ounces of starch based component, 12 to 120 ounces of gluten based component can be mixed in a vessel of water holding 5 to 25 gallons of all wet ingredients including paper/cellulose based component and starch reactive agent.

e.g. approximately 4 to 32 ounces of starch based component, 12 to 120 ounces of gluten based component all mixed in a water vessel holding 5 to 25 gallons of wet ingredients including paper/cellulose based component and starch reactive agent.

e.g. approximately 8 to 60 ounces of starch based component, 16 to 172 ounces of gluten based component mixed in a water vessel holding 5 to 50 gallons of all wet ingredients including paper/cellulose based component and starch reactive agents.

e.g. approximately 4 to 32 ounces of starch based component, 12 to 180 ounces of gluten based component. A vessel can be used to hold 5 to 30 gallons of all wet ingredients including paper/cellulose based component and starch reactive agent.

and also including above described aspects.

forming said mixture into a predefined shape to produce a formed mixture: e.g. wet, slurry, or otherwise fluid or semi-fluid pre-dehydrated substantially uniform mixture can be poured or otherwise introduced into forms, molds, extruded to form predefined shapes such as wall board/drywall, floor sheathing, laminate flooring and tiles, stenciled wall panels, textured wall boards, individual rocks, stones, and brick; crown molding and trim; green plywood; decorative cast fixtures; door insulation cores; sound proofing sheets of ships, particle board furniture and also including above described aspects.

treating said formed mixture with curing heat treatment with one or more starch agents to increase linking within portions of the one or more starch based components to produce a cured, formed mixture: e.g. cured through raising temperature to between 175 F to 225 F for a sufficient time to allow through a starch agent such a boron containing chemical compound such as a borate to result in cross linking between at least some of the starch molecules or molecules of one or more starch derivatives to be increased thereby allowing for potential for greater strength in resultant article of manufacture and also including above described aspects.

dehydrating said cured, formed mixture to remove a substantial portion of water from said cured, formed mixture to produce a dehydrated, cured, formed mixture: e.g. water moisture content dependent upon application such as less than 10%, less than 9%, less than 8%, less than 7%, less than 6%, less than 5%, less than 4%, less than 3% less than 2%, or less than 1%, etc., or of total weight of article, or such as the formed mixture is then further dehydrated a low heating temperature, such as between 100 F to 150 F until the preformed mixture is sufficiently dry to be considered solid sufficient for its intended serviceable function and also including above described aspects.

sealing at least portions of external surfaces of said dehydrated, cured, formed mixture to produce a sealed, dehydrated, cured, formed mixture: e.g. once the formed mixture has been cured and dehydrated to reduce its internal moisture content to a sufficient level, in implementations, at least the external surfaces exposed to air or other atmospheric conditions receive one or more coats of a sealant to prevent absorption by the dried formed mixture of water from the such air contacting such external surfaces. One or more sealants used can be either a green, organic based sealant such as an organic latex water sealant or laminant or a conventional sealant or laminant. Such green, organic based sealants can include such sealants as exemplary Safecoat DynoSeal, Safecoat WaterShield, SoySeal Wood Sealer and Waterprofer, SoyGuard Wood Sealer and Water Repellent, Rainforest Sealer, Zerovoc ZR44 Clear, Water Repelling Wood Sealer, Seal-Once™ eco-friendly waterproofers, and Aqua-Tite® GREEN Waterproofing. Conventional sealants can include Thompson Water Sealer, Dow Corning Water Sealer, Behr Water Sealer, Home Armor Waterproofing, and Olympic Water Guardand also including above described aspects.

Use of Trademarks in Specification Language:

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Caselaw-Driven Clarification Language:

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1-20. (canceled)

21. An article of manufacture comprising: one or more formed building-construction objects, substantially dehydrated subsequent to forming, formed from a substantially uniform mixture of components at least including one or more starch based components, one or more gluten based components, and one or more fibrous based components, said one or more starch based components having been treated to thereby increase linking within said one or more starch based components prior to dehydration.

22. The article of manufacture of claim 21 wherein the one or more formed building-construction objects comprises: one or more objects formed from a substantially uniform mixture poured or otherwise introduced into one or more forms, molds, or extrusions to form predefined shapes.

23. The article of manufacture of claim 21 wherein the one or more formed building-construction objects comprises: a water moisture content of less than 5% of total weight of the article of manufacture through being exposed to temperature of between 100° F. to 150° F.

24. The article of manufacture of claim 21 wherein the one or more formed building-construction objects is formed through one or more of mechanical blending of dry components, through thorough mechanical mixing of wet slurries, or of wet pastes.

25. The article of manufacture of claim 21 wherein the one or more formed building-construction objects comprises: one or more starches with glucose units joined by glycosidic bonds.

26. The article of manufacture of claim 21 wherein the one or more formed building-construction objects comprises: one or more of gluten containing materials or compounds that include gliadin and glutenin proteins.

27. The article of manufacture of claim 21 wherein the one or more formed building-construction objects comprises: one or more cellulosic materials including one or more ground, milled, or hammer milled, new or recycled, cotton, hemp, paper, or cardboard materials.

28. The article of manufacture of claim 21 wherein the one or more formed building-construction objects comprises: one or more objects cured through raising temperature to between 175° F. to 225° F. for a sufficient time to allow through a starch agent including one or more boron containing chemical compounds including one or more borates to result in cross linking between at least some of starch molecules or molecules of one or more starch derivatives of the one or more starch based components to be increased thereby allowing for potential for greater strength in the resultant one or more articles of manufacture.

29. The article of manufacture of claim 21 wherein the one or more formed building-construction objects include one or more planar surfaces.

30. The article of manufacture of claim 21 wherein the one or more formed building-construction objects include one or more door insulation cores.

31. The article of manufacture of claim 21 wherein the one or more formed building-construction objects include one or more wall board.

32. The article of manufacture of claim 21 wherein the one or more formed building-construction objects include one or more drywall.

33. The article of manufacture of claim 21 wherein the one or more formed building-construction objects include one or more floor sheathing.

34. The article of manufacture of claim 21 wherein the one or more formed building-construction objects include one or more laminate flooring.

35. The article of manufacture of claim 21 wherein the one or more formed building-construction objects include one or more tile material.

36. The article of manufacture of claim 21 wherein the one or more formed building-construction objects include one or more wall panels.

37. The article of manufacture of claim 21 wherein the one or more formed building-construction objects include one or more crown molding.

38. The article of manufacture of claim 21 wherein the one or more formed building-construction objects include one or more wall trim.
